(19) United States
(12) Patent Application Publication
(10) Pub. No.: US 2007/0110021 A1
(43) Pub. Date: May 17, 2007

(54) Method and system for directing a call for a mobile station to a band class in a wireless communication network

(76) Inventors: Vivek G. Naik, Deerfield, IL (US); R. S. Core, Cave Creek, AZ (US); Anuj Sahni, Oakbrook, IL (US); Christopher R. Schmidt, Pinole, CA (US)

Correspondence Address: MOTOROLA, INC., 1303 EAST ALGONQUIN ROAD, IL01/3RD, SCHAUMBURG, IL, 60196, US

(21) Appl. No.: 11/281,121

(22) Filed: Nov. 17, 2005

(51) Int. Cl. H04B 7/212

(52) U.S. Cl. 370/348; 370/209

(57) ABSTRACT

Methods and systems for directing a call for a mobile station (MS) (400) to a band class in a wireless communication network (100) are provided. The wireless communication network includes a plurality of band classes (125). The method comprises the MS idling (405) in a first band class. The first band class is among the plurality of band classes. The method further comprises the MS receiving (410) an overhead message (305). The overhead message contains an alternate band class of the plurality of band classes. Further, the wireless communication network sends the overhead message if a predetermined criteria is met on the first band class. The method further includes switching (415) to the alternate band class in response to receiving the overhead message when the MS initiates a connection.

### FIELD OF THE INVENTION

The invention relates generally to wireless communication networks. More specifically, the invention relates to directing a call for a mobile station to a band class in a wireless communication network.

### BACKGROUND OF THE INVENTION

Existing Code Division Multiple Access (CDMA) technology for a wireless communication network comprises a plurality of band classes, for example, a first band class and a second band class. A band class is associated with a particular frequency bandwidth and a particular signal modulation scheme and is used for communication in the wireless communication network. For example, a band class may be a 700 Megahertz (MHz) band class or a 1600 MHz band class. If the second band class has the capacity, the first band class sends an Extended System Parameter Message (ESPM) with an alternate band (ALT_BAND) indicator to a mobile station (MS) initiating a call to indicate that the second band class has the capacity. If the MS supports the second band class, the MS sends an Originating Request Message (ORM) to the first band class, in response to receiving the ESPM with the ALT_BAND indicator.

The wireless communication network then determines if an overload condition exists on the first band class. If so, an Extended Channel Assignment Message (ECAM) is sent through the first band class to the MS. The MS then uses a paging channel and sends an ORM to the second band class. The wireless communication network assigns the respective resources and sends an ECAM from the second band class to the MS. The MS is then moved from the shared channel to the traffic channel on the second band class. As a result, the conventional call setup process requires the transaction of multiple messages between an MS and the wireless communication network. Therefore, there is an inherent delay involved in setting up the call.

### BRIEF DESCRIPTION OF THE FIGURES

The accompanying figures, where like reference numerals refer to identical or functionally similar elements throughout the separate views and together with the detailed description below are incorporated in and form part of the specification, serve to further illustrate various embodiments and to explain various principles and advantages all in accordance with the invention.

FIG. 1 is a block diagram of a wireless communication network, in accordance with an embodiment of the invention.

FIG. 2 is a block diagram of the working of a wireless communication network, in accordance with an embodiment of the invention.

FIG. 3 is a block diagram of a wireless communication network, in accordance with an embodiment of the invention.

FIG. 4 is a flow diagram of a method for directing a call for a mobile station to a band class in a wireless communication network, in accordance with an embodiment of the invention.

FIG. 5 is a flow diagram of a method for directing a call for a mobile station in a wireless communication network, in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to directing a call for a mobile station to a band class in a wireless communication network. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the mobile station. The non-processor circuits may include, but are not limited to, a radio receiver, a radio transmitter, signal drivers, clock circuits, power source circuits, and user input devices. As such, these functions may be interpreted as steps of a method for directing the call during an overload in the multi band system. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments of the invention provide a method and system for directing a call for a mobile station (MS) to a band class in a wireless communication network. The wireless communication network includes a plurality of band classes. The method comprises the MS idling in a first band class. The first band class is among the plurality of band classes. The method further comprises the MS receiving an overhead message. The overhead message contains an alternate band class of the plurality of band classes. Further, the wireless communication network sends the overhead message if a predetermined criteria is met on the first band class. The method further includes switching to the alternate band class in response to receiving the overhead message when the MS initiates a connection.

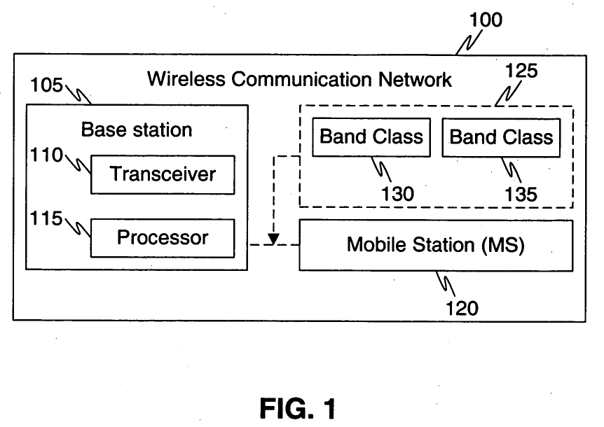

FIG. 1 is a block diagram of a wireless communication network 100, in accordance with an embodiment of the invention. The wireless communication network 100 can be a RAN and comprises at least one base station (for example, a base station 105). The base station 105 comprises a transceiver 110 and a processor 115 working in conjunction to direct a call for one or more MS 120 to a band class. The base station 105 communicates with the MS 120 through a plurality of band classes 125 (for example, a band class 130 and a band class 135). A band class is associated with a particular frequency bandwidth and a particular signal modulation scheme and is used for communication in the wireless communication network 100. For example, a band class may be a 700 Megahertz (MHz) band class or a 1600 MHz band class. It will be readily apparent to a person skilled in the art that the wireless communication network can have more than two band classes. In this embodiment of the invention, the MS 120 idles on the band class 130.

The transceiver 110 can be adaptively coupled with the processor 115. The processor 115 is configured to determine whether a predetermined criteria is met on the band class 130. The processor 115 is further configured to broadcast an overhead message to the MS in response to determining that the predetermined criteria is met on the band class 130 and to receive a message from the MS 120 in direct response to the overhead message, where the message requests a call on an alternate band class (for example, the band class 135).

The overhead message contains an alternate band class of the plurality of band classes 125. In an embodiment of the invention, the overhead message is an Extended System Parameter Message (ESPM). The ESPM may comprise an alternate band indicator (ALT_BAND indicator). The ALT_BAND indicator indicates one or more alternate band classes in the wireless communication network 100 that can be used for initiating a call by the MS 120. The ALT_BAND indicator may also further indicate the priority of the plurality of alternate band classes in the wireless communication network 100. The method of sending the overhead message by the wireless communication network 100 will be apparent to a person ordinarily skilled in the art.

In various embodiments of the invention, the wireless communication network 100 sends the overhead message (that contains the alternate band class of the plurality of band classes) if a predetermined criteria is met on the first band class. In an embodiment of the invention, the predetermined criteria comprise an overload condition on the first band class. A band class may be overloaded for example, but not limited to, if resource utilization on the band class exceeds a predetermined-threshold corresponding to the band class. Therefore, the MS may also use the overhead message to detect that the first band class is in overload conditions. In another embodiment of the invention, the predetermined criteria indicate that a predefined time interval has lapsed. For example, this can be performed periodically. In another example, this can be performed during peak hours of usage of the wireless communication network. In yet another embodiment of the invention, the predetermined criteria may be combinations thereof. For example, the predetermined criteria can be the first band class is overloaded for the predefined time interval.

The processor 115 may be further configured to determine priority of the plurality of alternate band classes and broadcast priority in the overhead message. In this embodiment of the invention, the ALT_BAND indicator further indicates the priority of each alternate band class. For example, if the wireless communication network 100 comprises a plurality of alternate band classes, the ALT_BAND indicator can indicate the priority of each alternate band class depending on the overload condition of each alternate band class. As a result, an alternate band class A can have a higher priority than an alternate band class B, if the alternate band class A is less overloaded than the alternate band class B. The processor 115 may also be configured to send an assignment message to the MS 120 in response to receiving an Origination Response Message (ORM) from the MS 120. In an embodiment of the invention, the assignment message indicates allocation of traffic channel resources to the MS on the alternate band class. The assignment message can be, for example, an Extended Channel Assignment Message (ECAM). The assignment message can further comprise the frequency of the alternate band class, Pseudonoise (PN) and Walsh Code (WC). The method of sending the assignment message will be apparent to a person ordinarily skilled in the art.

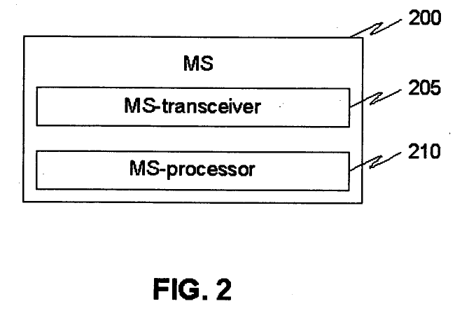

FIG. 2 is a block diagram of an MS 200, in accordance with an embodiment of the invention. The MS 120 may be similar to the MS 200. The MS 200 comprises an MS-transceiver 205 and an MS-processor 210. The MS-transceiver 205 can be adaptively coupled with the MS-processor 210. The MS-processor 210 is configured to receive an overhead message indicating that the MS 200 uses an alternate band class when the MS 200 is idling in the band class 130. If the MS 200 initiates a call, the MS-processor 210 is configured to determine if the MS 200 supports the alternate band class indicated by the overhead message. If the MS 200 supports the alternate band class, the MS-processor 210 is configured to send an ORM for initiating a call directly to the alternate band class in the wireless communication network 100. In an embodiment of the invention, the MS-processor 210 is configured to send the ORM to an alternate band class based on the priority of the alternate band class indicated by the overhead message.

The MS-processor 210 may further be configured to switch to the alternate band class when the MS-processor 210 receives the overhead message and supports the alternate band class. The MS-processor 210 is configured to receive an assignment message from the wireless communication network 100 in response to the ORM. The assignment message can include traffic channel information and an assign mode. The MS-processor 210 is configured to then determine the traffic channel and the assign mode included in the assignment message for the call set up.

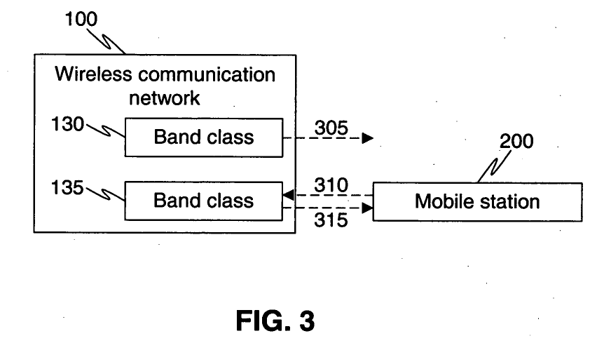

FIG. 3 is a block diagram of the working of the wireless communication network 100, in accordance with an embodiment of the invention. In this embodiment of the invention, the band class 130 is in the overload condition and broadcasts an overhead message 305 to one or more MS 200. The overhead message 305 indicates to the plurality of MS that the band class 130 is in the overload condition.

The MS 200 receives the overhead message 305 and continues to idle on the band class 130. The overhead message 305 comprises the ALT_BAND indicator indicating to the MS 200 an alternate band class that is available in the wireless communication network 100. The ALT_BAND indicator indicates to the MS 200 that the band class 135 can be used by the MS 200 to initiate the call. When the MS 200 initiates the call, the MS 200 determines if the band class 135 is supported by the MS 200. If the MS 200 does not support the band class 135 then the MS 200 initiates the call on the band class 130. If the MS 200 supports the band class 135, then the MS 200 sends an ORM 310 to the band class 135 to initiate the call. The wireless communication network 100 processes the ORM 310 sent by the MS 200 and sends an assignment message 315 to the MS 200 in response to the ORM 310 sent by the MS 200.

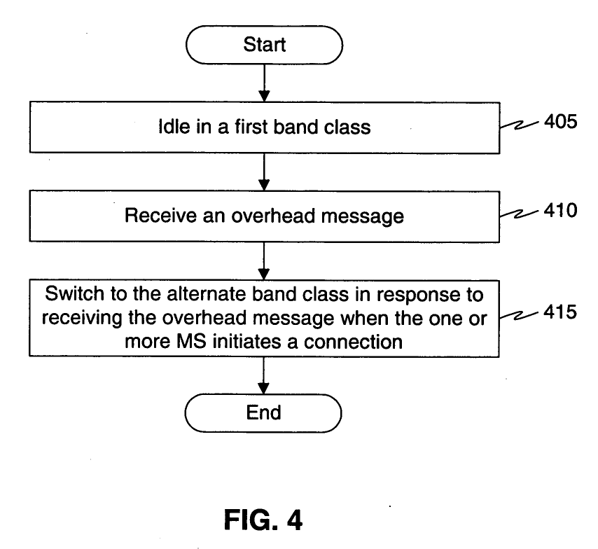

FIG. 4 is a flow diagram of a method for directing a call for a MS to a band class in a wireless communication network, in accordance with an embodiment of the invention. The wireless communication network can be, for example, a RAN. In an embodiment of the invention, the wireless communication network is a RAN in a Code Division Multiple Access (CDMA) system. The wireless communication network comprises a plurality of band classes. The MS idles 405 on a first band class (which can be for example, the band class 130). The first band class is among the plurality of band classes in the wireless communication network.

The MS receives 410 an overhead message. The overhead message contains an alternate band class (for example, the band class 135) of the plurality of band classes. In an embodiment of the invention, the overhead message is an ESPM. The ESPM may comprise an ALT_BAND indicator. This has been explained in detail in conjunction with FIG. 1. In various embodiments of the invention, the wireless communication network sends the overhead message (that contains the alternate band class of the plurality of band classes) if a predetermined criteria is met on the first band class. The predetermined criteria have been explained in detail in conjunction with FIG. 1.

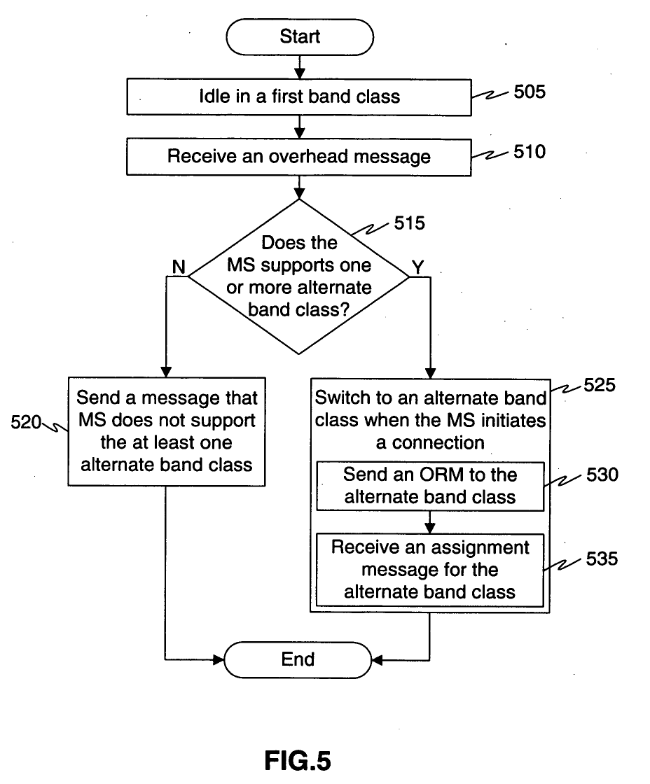

The MS switches 415 to the alternate band class in response to receiving the overhead message when the MS initiates the call. This is further explained in conjunction with FIG. 5.

FIG. 5 is a flow diagram for directing a call for a MS in a wireless communication network, in accordance with another embodiment of the invention. A MS idles 505 in a first band class. The MS receives 510 the overhead message from the wireless communication network. The overhead message contains an alternate band class of the plurality of band classes. For example, the overhead message may be an ESPM that comprises an ALT_BAND indicator. The MS then checks the overhead message to determine one or more alternate band class in which to operate. The MS then determines 515 whether the MS supports one or more alternate band class. If the MS does not support one or more alternate band class, the MS then sends 520 a message to the wireless communication network indicating that the MS does not support the at least one alternate band class.

However, if the MS supports one or more alternate band class, then the MS switches 525 to an alternate band class when the MS initiates a connection with the wireless communication network. In an embodiment of the invention, if the wireless communication has a plurality of alternate band class and one or more alternate band classes are determined to be supported by the MS, the MS then switches to an alternate band class that has a higher priority. To switch, the MS sends 530 an ORM to the alternate band class for initiating the call and receives 535 an assignment message for the alternate band class.

Various embodiments of the invention provide a method and a system to reduce the call set up duration as the MS sends an ORM directly to the alternate band class. Further, the various embodiments of the invention provide a method and system in which load on the wireless communication network is balanced without migrating the idle MS from the first band class to the alternate band class. Also, no registrations are involved before call setup procedure. As result, there is a reduction in the re-registration process in the wireless communication network.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for directing a call for a mobile station to a band class in a wireless communication network wherein the wireless communication network includes a plurality of band classes, the method comprising:
idling in a first band class, wherein the first band class is among the plurality of band classes
receiving an overhead message, the overhead message containing an alternate band class of the plurality of band classes, wherein the wireless communication network sends the overhead message if a predetermined criteria is met on the first band class; and
switching to the alternate band class in response to receiving the overhead message when the mobile station initiates a connection.

2. The method of claim 1, wherein the predetermined criteria comprise an overload condition on the first band class, wherein a band class is overloaded if resource utilization on the band class exceeds a predetermined-threshold corresponding to the band class.

3. The method of claim 1, wherein the predetermined criteria comprise a predefined time interval has lapsed.

4. The method of claim 1, wherein the switching step comprises:
sending an origination response message (ORM) to an alternate band class, the ORM being sent by the mobile station that supports the alternate band class; and
receiving an assignment message for the alternate band class.

5. The method of claim 4, wherein the assignment message indicates allocation of traffic channel resources to the mobile station on the alternate band class.

6. The method of claim 1, wherein the overhead message comprises an alternate band indicator, the alternate band indicator indicates at least one alternate band class in the wireless communication network.

7. The method of claim 6, wherein the alternate band indicator further indicates the priority of each alternate band class.

8. The method of claim 1 further comprising using the overhead message to detect that first band class is in overload conditions.

9. The method of claim 1 further comprising checking to determine if mobile station can support the alternate band class.

10. The method of claim 1 wherein the wireless communication network is a radio access network.

11. The method of claim 1 further comprising sending a message that the mobile station does not support the alternate band class.

12. The method of claim 1 further comprising checking the overhead message to determine the at least one alternate band class in which to operate.

13. A mobile station (MS) comprising:
an MS-transceiver; and
an MS-processor, the MS-transceiver adaptively coupled with the MS-processor, the MS-processor being configured to:
receive an overhead message indicating that the MS use an alternate band class when the MS is idling in a first band class;
determine whether the MS supports an alternate band class; and
send an origination response message (ORM) to an alternate band class directly in response to receiving an overhead message if the MS supports the alternate band class.

14. The mobile station of claim 13, wherein the MS-processor is configured to send the ORM to an alternate band class based on the priority of the alternate band class indicated by the overhead message.

15. The mobile station of claim 13 wherein the MS-processor is configured to determine that the first band class is in overload condition.

16. The mobile station of claim 13 wherein the MS-processor is configured to switch to the alternate band class when the MS-processor receives an overload message.

17. A wireless communication network comprising:
a plurality of band classes;
a transceiver; and
a processor, the transceiver adaptively coupled with the processor, the processor being configured to:
determine whether a predetermined criteria is met on a first band class, wherein at least one mobile station is idling on the first band class;
broadcast an overhead message to the at least one mobile station in response to determining whether the predetermined criteria is met on the first band class; and
receive a message from the at least one mobile station in direct response to the overhead message wherein the message requests a call on an alternate band class.

18. The wireless communication network of claim 17, wherein the processor is further configured to:
determine priority of the plurality of band classes; and
broadcast the priority in the overhead message.

19. The wireless communication network of claim 17, wherein the processor is further configured to:
send an assignment message to a mobile station in response to receiving an origination response message (ORM) from the mobile station.

20. The wireless communication network of claim 17 wherein the wireless communication network is a radio access network.
